(19) United States
(12) Patent Application Publication
(10) Pub. No.: US 2013/0031532 A1
(43) Pub. Date: Jan. 31, 2013

(54) METHOD, COMPUTER, AND DEVICE FOR VALIDATING EXECUTION OF TASKS IN ADAPTABLE COMPUTER SYSTEMS

(71) Applicants: Damien Guinier, Moirans (FR); Patrick Le Dot, Lancey (FR)

(72) Inventors: Damien Guinier, Moirans (FR); Patrick Le Dot, Lancey (FR)

(73) Assignee: BULL SAS, Les Clayes Sous Bois (FR)

(21) Appl. No.: 13/637,639

(22) PCT Filed: Mar. 22, 2011
(86) PCT No.: PCT/FR2011/050584

§ 371 Date: Sep. 26, 2012

(30) Foreign Application Priority Data
Mar. 26, 2010 (FR) 1052235

(51) Int. Cl. G06F 11/36; G06F 9/44

(52) U.S. Cl. 717/127

(57) ABSTRACT

The invention particularly relates to the validation of task execution in a testing environment that includes at least one cluster having a plurality of nodes, at least one of which includes a program for managing the performance of tests. After transmitting at least one characteristic of said nodes to a test element storage system, data representing at least one test enabling the execution of said task in said cluster is received (405) if said test element storage system includes data representing said at least one test that is compatible with said at least one characteristic. If the available resources for said cluster enable the execution of said task according to said received data representing said at least one test, said task is executed (435) according to said received data representing said at least one test, and at least one result, obtained during said execution, is sent (440).

The present invention concerns the validation of execution of software routines and more particularly a method, a computer program and a device for validating execution of tasks in adaptable computer systems.

In order to facilitate the programming of the computer systems, intermediate software layers are generally used between the hardware layer and the software application layer. Such intermediate layers enable execution of tasks that are as generic as possible, such as transfers and processing of data. Furthermore, the use of such tasks often enables the application and hardware layers to be dissociated, thus authorizing a software application to be executed by several different hardware layers.

Although those intermediate layers typically include the operating system used, they may also include particular tasks linked, in particular, to the optimization of the hardware resources. Thus, for example, in the field of high performance computing, certain tasks may be offered, marginal to the operating system, in order, in particular, to choose the mathematical algorithms giving the best performance according to the applications concerned.

Naturally, the execution of those tasks should be tested and validated in order for the results produced to satisfy certain predetermined characteristics, whatever the hardware layer used, or, at least, in order for the results produced to be characterized according to the hardware layer used.

Thus, the test and the validation of the execution of those tasks represent an essential phase of the development of computer systems comprising a hardware layer and an intermediate layer adapted to execute those tasks to detect failures and thus ensure a required level of reliability. These tests are generally directed to observing the behavior of the system executing those tasks in predetermined sequences, that is to say according to particular test data, in order to compare the results obtained with expected results.

The computer systems implementing those tasks adapt over time in order to correct possible errors observed and in order to improve their performance or integrate new functionalities. Such adaptations may concern hardware components of the computer system, the hardware architecture or the configuration of those components as well as part of the intermediate software layer such as a operating system. Still with the aim of reliability, the execution of those tasks on those modified systems must again be verified to ensure that performance has not degraded. This is thus a non-regression test. For these purposes, the tests aim to observe the behavior of the modified system executing the tasks considered on the basis of test data in order to compare the results obtained with expected results or earlier results.

There are numerous strategies for testing and validation. However, a test is typically linked to an environment, that is to say a hardware and software configuration, test data, that is to say sequences of calls to the tested tasks and their parameters, and a method of obtaining or of analysis of the results. A number of combinations results therefrom which may be particularly high. In order to facilitate the operations of testing and validation, these latter are generally automated on the basis of a mechanism of nested loops to perform all the tests exhaustively or according to predetermined scenarios. For these purposes, a hardware environment is often dedicated to that function. It is configured according to the tests and validations to perform.

FIG. 1 is a diagrammatic illustration of a system for testing execution of tasks in a computer system.

As illustrated, the system for testing and validation 100 comprises a hardware test environment 105, itself comprising a plurality of computers, generally grouped into clusters, as well as a database 110 here containing the data for testing and validation and the configuration parameters of the test environment. The system for testing and validation 100 further comprises a control system 115, for example a computer or a server, for identifying the tests and validations to be carried out, configuring the test environment, sending the test data, receiving the results obtained and comparing those results with the expected results.

Thus, to perform a particular test using the system 100, a first step consists of identifying that test and of obtaining the corresponding data. A following step concerns the configuration of the test environment. It is directed in particular to determining the computers to be used, that is to say, for example, a particular cluster, and their implementation. It also concerns the configuration of the interconnections between the computers, that is to say the configuration of the network or the architecture used. The networks are, for example, Ethernet networks or InfiniBand type networks. It is possible to define a test environment according to the cluster to be used, a version of the operating system implemented and a particular architecture. Lastly, the test data and the definitions or rules for obtaining the results sought are identified for launching the test. The results obtained are then processed and compared with the results expected by the control system 115.

These steps are repeated for each test to be carried out.

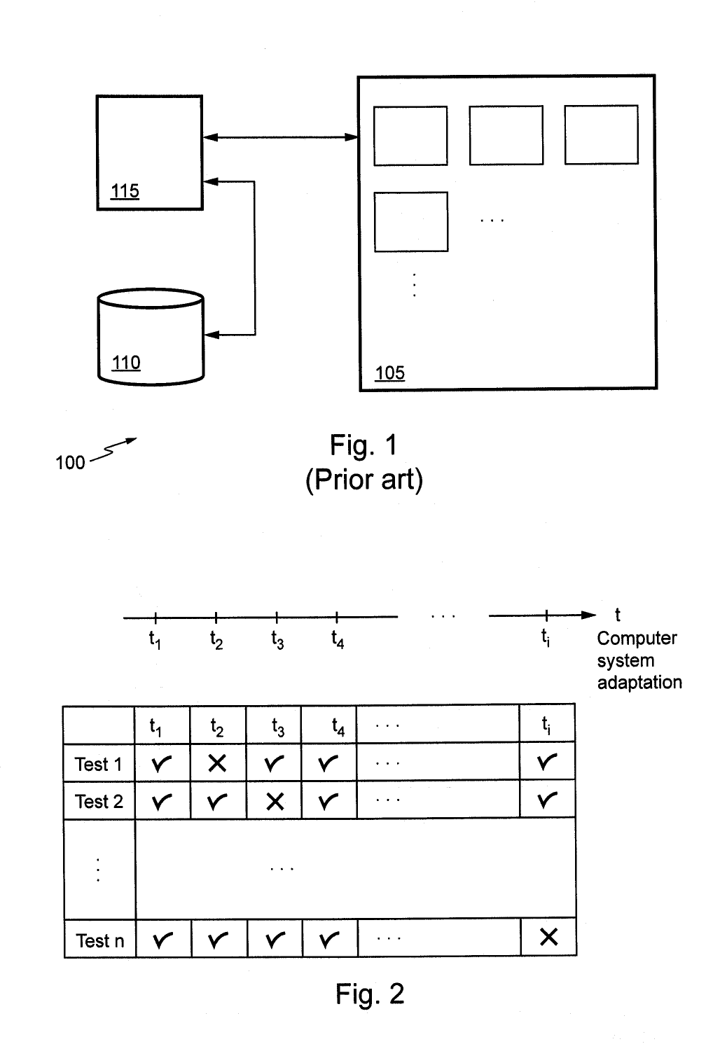

FIG. 2 is a diagrammatic representation of the results of tests and validations carried out for a computer system that adapts over time. The tests are carried out here at the times t₁, t₂, . . . , tₙ. Each test (tests 1 to n) here corresponds to a particular test environment as well as to particular test data, for example test data coming from different suppliers.

The test and validation results are compared here with expected results to determine an indication of success (√) or of failure (×). The results are, for example, data transmission rates, response times and processing times. These results may be presented in a table such as that illustrated in FIG. 2 in which each row corresponds to a particular test and each column corresponds to a test time or timestamp.

It is observed here that an error in relation to a particular test may be an error linked to the result of the test, that is to say an erroneous result in relation to an item of test data, but may also be linked to the change, over time, of results of the test if no modification of the computer system has been made theoretically affecting the result. Thus, for example, if a failure is observed for a given test, the observation of an indication of success of that test without any modification of the computer system linked to that test having been made may be interpreted as a potential error.

However, while a test and validation system such as the one presented with reference to FIGS. 1 and 2 makes it possible to efficiently test and validate the execution of static tasks in computer systems, it does not enable the optimal use of the adaptable hardware test environment. This results in particular in a waste of time linked to the sequencing of the tests and under-use of the results of the test system.

The invention enables at least one of the problems set forth above to be solved.

The invention thus relates to a method of validating execution of at least one task for an adaptable computer system in a test environment comprising at least one cluster, each of said at least one cluster comprising a plurality of nodes, at least one node of said plurality of nodes of each of said at least one cluster comprising a program resident in memory, said program resident in memory, referred to as the program, comprising the following steps,
to a system for storing test elements, sending at least one characteristic of said plurality of nodes of the cluster to which belongs the node that includes said program;
in response to said sending step, if said system for storing test elements comprises data representing at least one test of said at least one task compatible with said at least one characteristic, receiving said data representing said at least one test enabling the execution of said at least one task in the cluster to which belongs the node that includes said program; and,
if the available resources of the cluster to which belongs the node that includes said program enabling the execution of said at least one task according to said received data representing said at least one test, performing the execution of said at least one task according to said received data representing said at least one test and sending at least one result obtained during said execution.

The method according to the invention thus makes it possible to optimize the resources of a test environment comprising a cluster grouping several nodes at the time of the execution of tests by enabling use in parallel of pooled resources.

Advantageously, said step of receiving data enabling the execution of said at least one task comprises a step of receiving at least one item of configuration data of the environment of the cluster to which belongs the node that includes said program, the method further comprising a step of configuring the environment of the cluster to which belongs the node that includes said program according to said item of received configuration data. The method according to the invention thus makes it possible to configure the test environment according to the tests to perform.

Said step of receiving data enabling the execution of said at least one task further comprises, preferably, a step of receiving at least one item of data for determining an execution result of said at least one task, the method further comprising a step of determining at least one execution result of said at least one task according to said at least one item of data received for determining an execution result of said at least one task. The method according to the invention thus makes it possible to configure the manner in which the test execution results are evaluated.

According to a particular embodiment, the method further comprises a step of creating said at least one test of said at least one task according to said received data representing said at least one test. The method according to the invention thus makes it possible to create dynamic tests on the basis of referring test elements, thus increasing the test possibilities.

Still according to a particular embodiment, the method further comprises a step of creating an entry in a routine execution table in response to said step of receiving data enabling the execution of said at least one task, said routine execution table enabling the automatic execution of said at least one task.

Advantageously, the method further comprises a step of sending a command to an external system for ordering the sending of a report of execution of said at least one task. The test environment is thus adapted to manage the execution of tests and to autonomously control the test report sending.

Still according to a particular embodiment, said system for storing test elements comprises a database, said database comprising environment data, test data, analysis data and task data, said step of sending said at least one characteristic of said plurality of nodes of the cluster to which belongs the node that includes said program comprising a request for access to said database.

Advantageously, a plurality of tests is executed simultaneously.

The invention also relates to a computer program comprising instructions adapted to the implementation of each of the steps of the method described earlier as well as a device comprising means adapted to the implementation of each of the steps of the method described earlier.

The advantages procured by that computer program and that device are similar to those referred to above.

Other advantages, objects and features of the present invention will emerge from the following detailed description, given by way of non-limiting example, relative to the accompanying drawings in which:

FIG. 1 is a diagrammatic illustration of a system for testing execution of tasks in a computer system;

FIG. 2 is a diagrammatic representation of the results of tests carried out for a computer system that adapts over time.

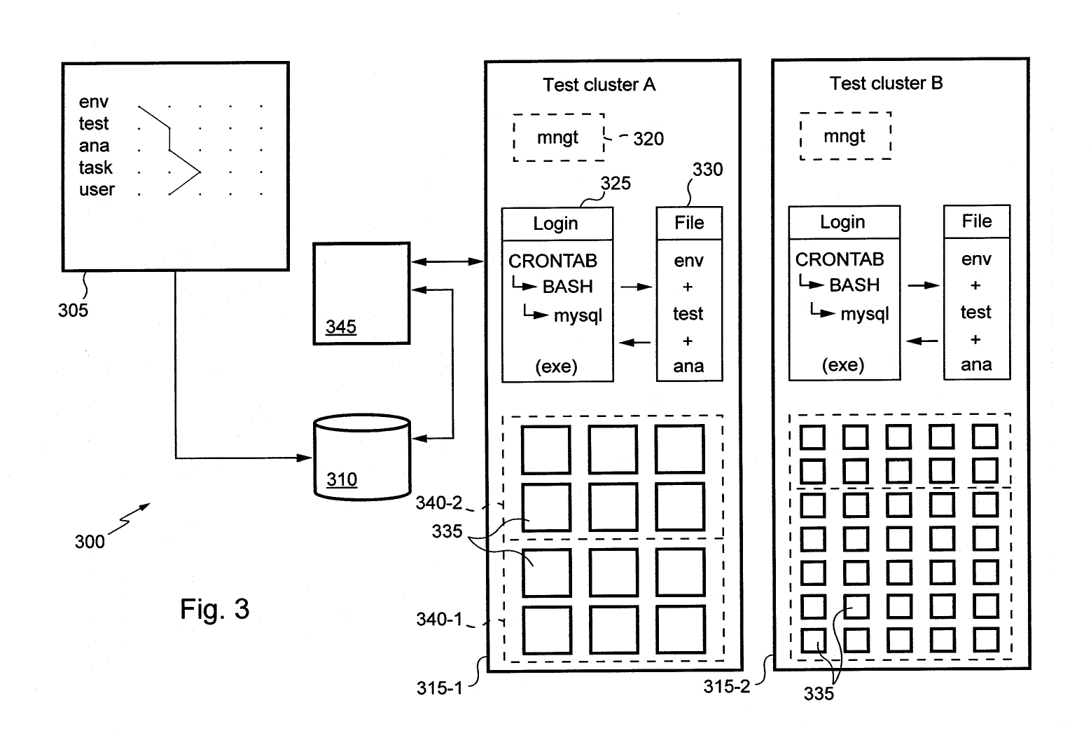

FIG. 3 is a diagrammatic illustration of a test and validation environment for executing tasks implementing the invention;

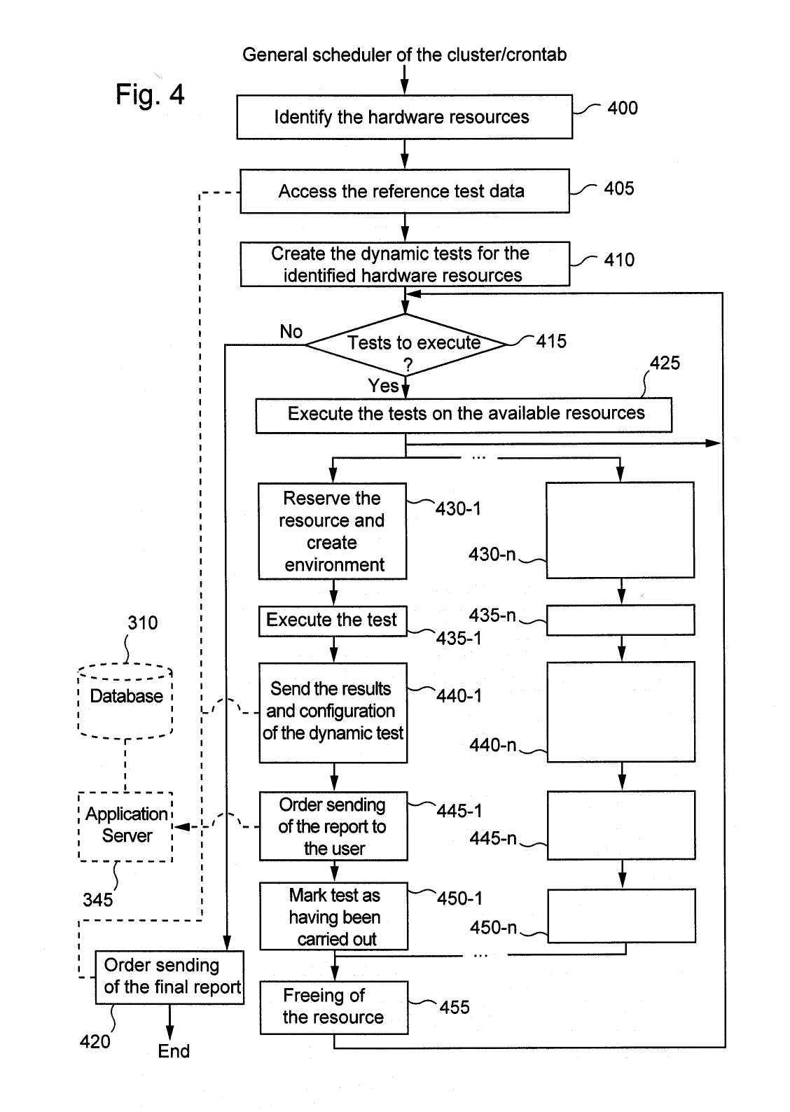

FIG. 4 is a diagram of an algorithm implemented in a program resident in memory of an input node of a cluster belonging to a test and validation environment; and,

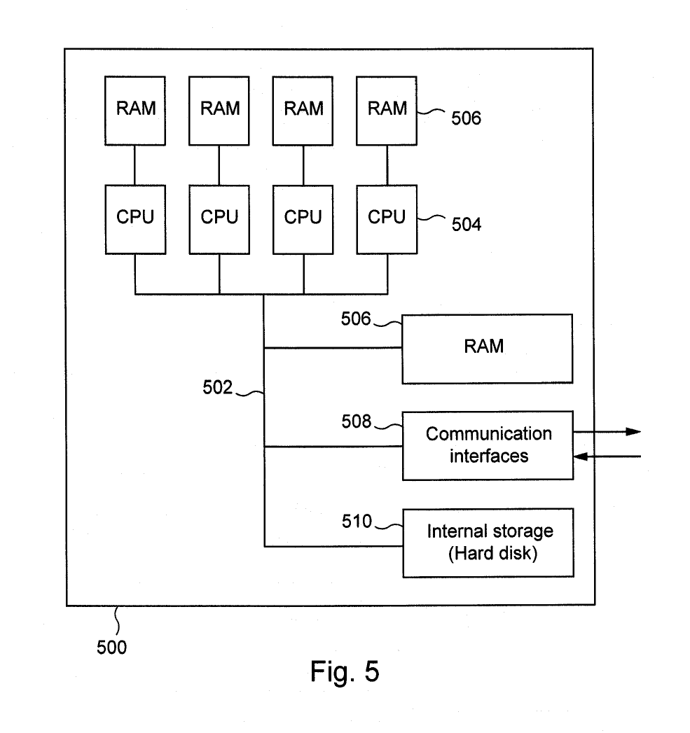

FIG. 5 illustrates an example of architecture of a node of a cluster adapted to implement the invention.

The invention relates in particular to managing the execution of tests, that is to say sequences of tasks associated with result analysis and configuration data, based on the test clusters themselves, according to their capabilities, to enable the validation of the execution of those tasks and to optimize the execution of those sequences.

According to a particular embodiment, a test environment is constituted by several clusters each comprising a set of nodes. A particular node of each cluster, referred to as input node or login node, comprises a program resident in memory to automatically launch sequences of tasks.

When the invention is implemented in an environment based on an operating system of Linux type (Linux being a trademark), such a program typically comprises the crond. This program, combined with a program of binary or shell script type, that is to say a program enabling access to the operating system, makes it possible in particular to identify the resources of the cluster as well as its execution environment in order to launch sequences of tasks able to be executed in the identified configuration. In other words, on the basis of the identified configuration information, it is possible to determine the tests that can be carried out, to access the data enabling the execution of the sequences of tasks associated and to launch their execution when the necessary resources are available.

For these purposes, a database comprises a list of scheduled tasks, and, for each scheduled task, the list of the clusters capable of executing the corresponding sequences of tasks. This database also comprises referring tests themselves comprising sequences of tasks to execute, execution environments and information relating to obtaining and analyzing the test results. Thus, after having identified the scheduled tasks able to be carried out, the program resident in memory of each input node of each cluster may create corresponding dynamic tests on the basis of referring tests and launch the associated sequences of tasks according to the available resources.

FIG. 3 is a diagrammatic illustration of a test and validation environment 300 for executing tasks implementing the invention.

A table 305 is used here to determine the tests to perform by combining parameters. A dynamic test to perform is defined here by the combination of referring test elements, that is to say, for example, the association of an environment, of test data, of analysis rules, of tasks and of a user. Thus, as illustrated in table 305 by a link of association representing a scheduled task, a dynamic test may be created from indications directed to referring test elements and the elements concerned themselves. The referring tests as well as the scheduled tasks are stored here in the database 310.

It is observed here that the referring tests may comprise elements of different nature, for example hardware targets to be used on execution of the tests.

The test environment also comprises test clusters, here test clusters 315-1 and 315-2, also called test clusters A and B.

Each test cluster comprises a set of nodes linked together according to a predefined or configurable architecture and a management system generically referenced 320 linked to a particular node or shared between several nodes. A particular node 325, called input node or login node, is used to access the cluster from an external system. The input node comprises a program resident in memory, generically referenced 325. The input node is also used to send the test results obtained to an external system.

The nodes of the cluster used to execute the tasks corresponding to a dynamic test are here generically referenced 335.

An application system for evaluating the results is furthermore used to compare the results obtained with the expected results. Here it is a PHP Apache application server 345. It is, preferably, used to exchange data between the test clusters and the database 310.

As described earlier, the program resident in memory of the input node 325 has in particular the object of determining the resources of the cluster on which it is implanted and to access the test elements stored in the database 310 in order to create the dynamic tests and to launch the execution of the sequences of tasks corresponding to those tests when the necessary resources are available and to send the obtained results to that database.

More particularly, the test elements obtained from the database 310 according to the resources of the cluster are used to create the dynamic tests which are stored in the files 330, it being possible for example for each test to be stored in a separate file. Advantageously, these files store, for each test, the test environment, comprising, for example, a reference to an operating system and to the version to be used, the test data, that is to say here the tasks to execute and their parameters, and the analysis rules to obtain the results. These files may also be used for temporarily storing the test results before they are sent to the database 310 from which they may be processed and analyzed by the application server 345. The files 330 are, for example, stored in the file system of the cluster.

FIG. 4 is a diagrammatic representation of an example of an algorithm implemented in a program resident in memory of an input node of a cluster belonging to a test environment to perform dynamic tests according to the resources of the cluster. As stated, this algorithm is called by the overall scheduler of the cluster considered or by its crontab.

A first step (step 400) is directed to obtaining characteristics of the cluster, in particular those relating to its hardware resources, for example the number of nodes, their type and the configuration of the interconnections between the nodes. It may also be a predetermined reference, for example the name or a reference of the cluster.

These characteristics may also comprise the operating system implemented and its version. However, such characteristics are, preferably, associated with each test such that the operating system required is implemented.

A following step (step 405) is directed to obtaining scheduled tasks and referring test data according to the characteristics of the cluster. By way of illustration, this step may takes the form of SQL queries (SQL standing for Structured Query Language) comprising the characteristics of the cluster, for example its name, its microprocessor type and its software configuration. It is sent here to the database 310 via the application server 345 as described earlier.

In response to that request, the input node of the cluster receives test elements enabling creation of one, several or all the dynamic tests that can be carried out and having to be carried out by the cluster at the origin of the request (step 410). These data, received here from the database 310 via the application server 345, advantageously comprise, for each dynamic test, the following information:
the test environment, that is to say, for example, the number of nodes to use, the configuration of their interconnection, the environment variables and the operating system to use;
the test data, that is to say, in particular, the sequence of tasks to be executed as well as the execution parameters of those tasks; and,
the rules for analysis, that is to say the rules making it possible to obtain the test results to be sent in response to the execution of the test.

The data received from referring tests or the dynamic tests created are, preferably, stored in files (files 330 in FIG. 3).

A following step is directed to determining whether there are any dynamic tests left to be executed (step 415). If there is no dynamic test to be executed, a command is sent to the application server 345 to order it to send the client at the origin of the dynamic tests carried out a final report on the execution of those tests (step 420). This report comprises, for example, the test results. The algorithm then ends.

If, on the contrary, there is at least one dynamic test to perform, a following step is directed to identifying the dynamic tests to be executed according to the available resources of the cluster (step 425).

For these purposes, the available resources are compared with the resources necessary for executing the tasks identified via a routine execution table to determine the tests able to be executed.

If the resources do not enable at least one of the tests to be executed, this step is repeated until an interruption stops the system or until resources become free to enable a test to be performed.

If, on the contrary, the available resources of the cluster enable the execution of a sequence of tasks corresponding to one or more dynamic tests, these are selected in the routine execution table. This may, for example, be the first tests able to be executed on the basis of an index of the routine execution table. To execute the sequence of tasks corresponding to a test, the data of that test are obtained from the corresponding file in order to configure the environment and compile the test applications (if necessary, according to the operating system used).

As illustrated with the arrow looping back to step 415, step 425 is executed so long as there are dynamic tests left to be executed.

The resources necessary for executing the selected tests are then reserved for each of those dynamic tests (step 430-1, 430-n) and the sequence of tasks is launched by the execution of those dynamic tests (step 435-1, 435-n). The results obtained on execution of the sequence of tasks, according to the rules of analysis used, are stored here in the file associated with the test.

It is observed that the step for reserving resources (step 430) may comprise a step of reinitializing nodes of the cluster or of changing the operating system, that is to say step of completely wiping the software.

When the sequence of tasks corresponding to a dynamic test has been executed, the results obtained as well as, preferably, the configuration of the dynamic test are sent (step 440-1, 440-n) to the database 310 via the application server 345 to be processed and analyzed by an evaluating system in order to validate or not validate the execution of the tasks and to construct a representation of the test and validation results such as that described with reference to FIG. 2.

A command is then sent to the application server 345 to order it to send the client at the origin of the dynamic test carried out a report on the execution of that test (step 445-1, 445-n). The dynamic test carried out is then marked as carried out (step 450-1, 450-n) in order for it not to be selected again.

As soon as a dynamic test has been executed, the corresponding resources are freed (step 455). The algorithm then returns to step 415 to determine whether any dynamic tests are in course of execution or remain to be executed. If there is no dynamic test in course of execution or to be executed, a command is sent to the application server 345 to order it to send the client at the origin of the dynamic tests carried out a final report on the execution of those tests (step 420) and the algorithm ends.

As illustrated by references 430-i to 450-i, several tests may be executed simultaneously by a cluster, so enabling use in parallel of pooled resources. Sequences of tasks may thus be launched even though other sequences of tasks are in course of execution. It must be observed here that it is not necessary to synchronize the steps linked to the execution of a dynamic test with the corresponding steps of another dynamic test. In other words, the execution of the steps 430-i to 450-i is independent from the execution of steps 430-j to 450-j.

An example of architecture for a cluster adapted to implement the algorithm described with reference to FIG. 4 is illustrated in FIG. 5.

The device 500 here comprises a communication bus 502 to which there are connected:
central processing units (CPUs) or microprocessors 504;
components of a random access memory (RAM) 506, comprising registers adapted to record variables and parameters created and modified during the execution of the aforementioned programs. As illustrated, each component of random access memory may be associated with a microprocessor or be common to the elements of the device 500; and,
communication interfaces 508 adapted to send and to receive data.

Preferably, the device 500 further comprises internal storage means 512, such as hard disks, able in particular to contain the executable code of programs enabling the device 500 to implement the process according to the invention and data processed or to be processed according to the invention.

The communication bus allows communication and interoperability between the different elements included in the device 500 or connected to it. The representation of the bus is non-limiting and, in particular, the microprocessors may communicate instructions to any element of the device 500 directly or by means of another element of the device 500.

More generally, the program or programs implemented may be loaded into one of the storage or communication means of the device 500 before being executed.

The microprocessors 504 control and direct the execution of the instructions or portions of software code of the program or programs according to the invention. On powering up, the program or programs which are stored in a non-volatile memory, for example a hard disk, are transferred into the random-access memory 506 which then contains the executable code of the program or programs according to the invention, as well as registers for storing the variables and parameters necessary for implementation of the invention.

Naturally, to satisfy specific needs, a person skilled in the art will be able to make modifications in the preceding description.

1.-10. (canceled)

11. A method of validating execution of at least one task for a computer system in a test environment, the computer system including a cluster comprising a plurality of nodes, wherein at least one of the nodes comprises instructions configured to cause the node to perform the method, wherein the method comprises:
sending at least one characteristic of the cluster to a system for storing test elements;
determining whether the system for storing test elements has a test related to the characteristic;
based on whether the system for storing test elements has a test related to the characteristic at the node, receiving from the system for storing test elements, test data representing a test configured to execute the task;
determining whether resources for executing the test are available;
based on whether resources for executing the test are available at the node, executing the test to generate a result; and
sending the result to a database.

12. The method according to claim 11, wherein the received test data comprises at least one item of configuration data of the environment of the cluster, the method further comprising configuring the environment of the cluster according to the received configuration data.

13. The method according to claim 11, wherein the received test data comprises at least one item of data for generating the result, the method further comprising determining at least one result of the test according to the data item.

14. The method according to claim 11, further comprising generating the test based on the received test data.

15. The method according claim 11, further comprising generating an entry in a routine execution table in response to the received test data, wherein the routine execution table is configured to enable the automatic execution of the task.

16. The method according to claim 11, further comprising sending a command to an external system for ordering the sending of a report of execution of the task.

17. The method according to claim 11, wherein the system for storing test elements comprises the database, wherein the database comprises environment data, test data, analysis data and task data, and wherein sending the at least one characteristic includes sending a request for access to the database.

18. The method according to claim 11, wherein a plurality of tests is executed simultaneously.

19. A computer readable medium comprising instructions, which, when executed cause the computer to perform a method of validating execution of at least one task for a computer system in a test environment, the computer system including a cluster comprising a plurality of nodes, wherein at least one of the nodes comprises instructions configured to cause the node to perform the method, the method comprising:
sending at least one characteristic of the cluster to a system for storing test elements;
determining whether the system for storing test elements has a test related to the characteristic;
based on whether the system for storing test elements has a test related to the characteristic at the node, receiving from the system for storing test elements, test data representing a test configured to execute the task;
determining whether resources for executing the test are available;
based on whether resources for executing the test are available at the node, executing the test to generate a result; and
sending the result to a database.

20. The medium according to claim 19, wherein the received test data comprises at least one item of configuration data of the environment of the cluster, the method further comprising configuring the environment of the cluster according to the received configuration data.

21. The medium according to claim 19, wherein the received test data comprises at least one item of data for generating the result, the method further comprising determining at least one result of the test according to the data item.

22. The medium according to claim 19, the method further comprising generating the test based on the received test data.

23. The medium according claim 19, the method further comprising generating an entry in a routine execution table in response to the received test data, wherein the routine execution table is configured to enable the automatic execution of the task.

24. The medium according to claim 19, the method further comprising sending a command to an external system for ordering the sending of a report of execution of the task.

25. The medium according to claim 19, wherein the system for storing test elements comprises the database, wherein the database comprises environment data, test data, analysis data and task data, and wherein sending the at least one characteristic includes sending a request for access to the database.

26. The medium according to claim 19, wherein the method includes executing a plurality of tests simultaneously.

27. A computing device in a cluster of nodes within a computer system, wherein the computing device comprises:
means for sending at least one characteristic of the cluster to a system for storing test elements;
means for determining whether the system for storing test elements has a test related to the characteristic;
means for receiving, based on whether the system for storing test elements has a test related to the characteristic at the node, configured to receive from the system for storing test elements test data representing a test configured to execute the task;
means for determining whether resources for executing the test are available;
means for executing based on whether resources for executing the test are available at the node, configured to execute the test to generate a result; and
means for sending the result to a database.

28. The device according to claim 27, wherein the received test data comprises at least one item of configuration data of the environment of the cluster, the device further comprising means for configuring the environment of the cluster according to the received configuration data.

29. The device according to claim 27, wherein the received test data comprises at least one item of data for generating the result, the device further comprising means for determining at least one result of the test according to the data item.

30. The device according to claim 27, the device further comprising means for generating the test based on the received test data.

31. The device according to claim 27, the device further comprising means for generating an entry in a routine execution table in response to the received test data, wherein the routine execution table is configured to enable the automatic execution of the task.

32. The device according to claim 27, the device further comprising means for sending a command to an external system for ordering the sending of a report of execution of the task.

33. The device according to claim 27, wherein the system for storing test elements comprises the database, wherein the database comprises environment data, test data, analysis data and task data, and wherein sending the at least one characteristic includes sending a request for access to the database.

34. The device according to claim 27, wherein the device further comprises means for executing a plurality of tests simultaneously.
